(19) United States
(12) Patent Application Publication
(10) Pub. No.: US 2025/0282015 A1
(43) Pub. Date: Sep. 11, 2025

(54) CONTROL DEVICE, MACHINE TOOL, AND CONTROL METHOD

(71) Applicant: FANUC CORPORATION, Minamitsuru-gun, Yamanashi (JP)

(72) Inventor: Yuuta IMAMATSU, Minamitsuru-gun (JP)

(73) Assignee: FANUC CORPORATION, Minamitsuru-gun, Yamanashi (JP)

(21) Appl. No.: 18/862,641

(22) PCT Filed: May 12, 2022
(86) PCT No.: PCT/JP2022/020030

§ 371 Date: Nov. 4, 2024

(51) Int. Cl. B23Q 15/12

(52) U.S. Cl. CPC B23Q 15/12

(57) ABSTRACT

A control device for a machine tool comprises: an acquisition unit that acquires the type of a tool used for machining a machining object; a determination unit that determines, on the basis of the type of the tool, whether the operation of a mist collector is permitted or prohibited; and a collector control unit that turns ON the mist collector if it is determined that the operation of the mist collector is permitted, and turns OFF the mist collector if it is determined that the operation of the mist collector is prohibited.

### TECHNICAL FIELD

The present invention relates to a control device for controlling a machine tool including a mist collector, a machine tool related to the control device, and a control method.

### BACKGROUND ART

A mist collector collects mist generated in a machining area of a machine tool (see also JP 2012-076006 A). The mist collector collects the mist within the machining area, and prevents the mist from leaking out to the exterior of the machining area. The mist includes vaporized coolant.

### SUMMARY OF THE INVENTION

In the mist collector, vibration may occur during operation of the mist collector. In this case, there is a concern that the vibration generated by the mist collector affects the machining on a workpiece and the machine accuracy is reduced.

An object of the present invention is to solve the aforementioned problem.

A first aspect of the present invention is a control device for a machine tool including a mist collector configured to collect mist in a machining area, the machine tool being configured to machine a workpiece within the machining area, the control device including an acquisition unit configured to acquire a type of a tool used for performing machining on the workpiece, a determination unit configured to determine whether to permit or prohibit an operation of the mist collector based on the type of the tool, and a collector control unit configured to turn ON the operation of the mist collector in a case that a determination has been made to permit the operation of the mist collector, and turn OFF the operation of the mist collector in a case that a determination has been made to prohibit the operation of the mist collector.

A second aspect of the present invention is a machine tool including the control device according to the first aspect.

A third aspect of the present invention is a control method for controlling by a computer a machine tool including a mist collector configured to collect mist in a machining area, the machine tool being configured to machine a workpiece within the machining area, the control method including an acquisition step of acquiring a type of a tool used for performing machining on the workpiece, a determination step of determining whether to permit or prohibit an operation of the mist collector based on the type of the tool, and a collector control step of turning ON the operation of the mist collector in a case that a determination has been made to permit the operation of the mist collector, and turning OFF the operation of the mist collector in a case that a determination has been made to prohibit the operation of the mist collector.

According to the present invention, for example, in the case that a workpiece is machined by a tool used for precision machining, the collection of mist by the mist collector can be stopped. Therefore, it is possible to prevent the vibration generated by the mist collector from affecting the machining on the workpiece. As a result, it is possible to suppress degradation of the machine accuracy.

### BRIEF DESCRIPTION OF DRAWINGS

FIG. 1 is a schematic diagram of a machine tool according to an embodiment;

FIG. 2 is a block diagram of a control device;

FIG. 3 is a flowchart illustrating a control method according to the embodiment;

FIG. 4 is a schematic diagram of a machine tool according to an exemplary modification 1; and

FIG. 5 is a block diagram of a control device according to an exemplary modification 2.

### DETAILED DESCRIPTION OF THE INVENTION

### Embodiment

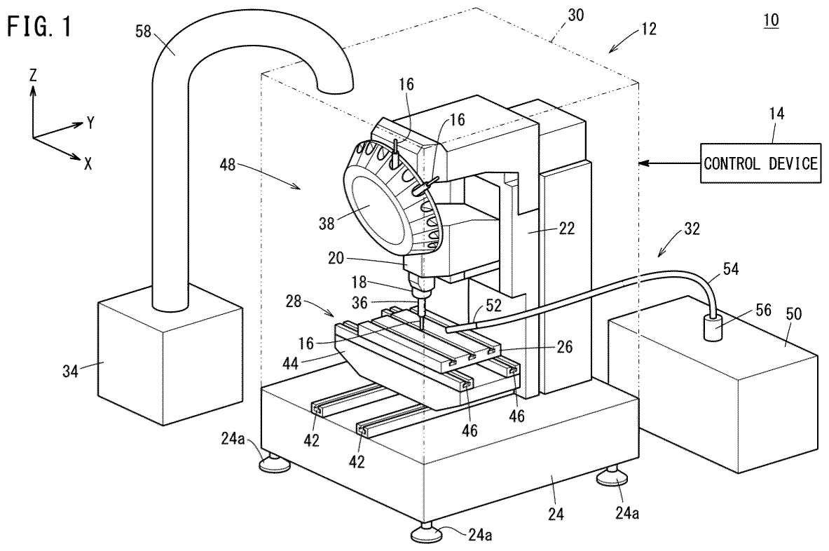

FIG. 1 is a schematic diagram of a machine tool 10 according to an embodiment.

The X direction and the Y direction shown in FIG. 1 are directions that are parallel to a horizontal plane. The X direction and the Y direction are mutually orthogonal with each other. The Z direction shown in FIG. 1 is a direction that is parallel to the direction of gravity. Accordingly, the Z direction is perpendicular to the X direction and the Y direction. However, the Z direction shown in FIG. 1 indicates a direction that is opposite to the direction of gravity.

The machine tool 10 includes a machining device 12 and a control device 14.

The machining device 12 is a machine device that carries out machining on a workpiece using a tool 16. The machining device 12 is equipped with a spindle 18, a spindle head 20, a column 22, a pedestal 24, a table 26, a table drive unit 28, a cover 30, a coolant supply device 32, and a mist collector 34.

A tool holder 36 is attached to the spindle 18. The tool holder 36 is capable of being attached and detached to and from the spindle 18. The tool holder 36 retains the tool 16. The tool 16, for example, is a spring-necked turning tool, a drill, an end mill, a milling cutter, or the like.

The machining device 12 is further equipped with a tool magazine 38. The tool magazine 38 detachably retains a plurality of the tools 16. One of the plurality of the tools 16 that are retained in the tool magazine 38 is changeably attached to the tool holder 36.

The spindle head 20 supports the spindle 18. Further, the spindle head 20 includes a motor that causes the spindle 18 to be rotated. The tool 16, which is attached to the spindle 18 via the tool holder 36, rotates together with the spindle 18.

The column 22 supports the spindle head 20. Further, the column 22 includes a motor that causes the spindle head 20 to be moved in the Z direction. The column 22 is supported on the pedestal 24.

The pedestal 24 is installed on an installation surface. The installation surface, for example, is a floor of a factory. The installation surface may be a support surface of a platform that is provided on the floor. The installation surface extends, for example, parallel to the horizontal plane. The pedestal 24 may be equipped with a plurality of leg members 24a. Each of the leg members 24a, for example, may be a caster, a jack, or the like.

The table drive unit 28 is supported on the pedestal 24. The table drive unit 28 is equipped with a first slide unit 42, a saddle 44, and a second slide unit 46.

The first slide unit 42 is installed on the pedestal 24. The first slide unit 42 includes, for example, guide rails that extend in the Y direction. The first slide unit 42 supports the saddle 44.

The saddle 44 moves in the Y direction in accordance with the driving of a non-illustrated motor. The motor is controlled by the control device 14. The saddle 44 moves while being guided by the first slide unit 42.

The second slide unit 46 is mounted on the saddle 44. The second slide unit 46 includes, for example, guide rails that extend in the X direction.

The table 26 supports a non-illustrated workpiece downwardly of the spindle 18. The table 26 is supported on the second slide unit 46. The table 26 moves in the X direction in accordance with the driving of a non-illustrated motor. The motor is controlled by the control device 14. The table 26 moves while being guided by the second slide unit 46.

The cover 30 covers the spindle 18, the spindle head 20, the column 22, the pedestal 24, the table 26, and the table drive unit 28. Consequently, the cover 30 forms a machining area 48. A workpiece is machined within the machining area 48.

The cover 30 is further equipped with a non-illustrated door and a non-illustrated window. The operator can carry out an introduction operation of the workpiece into the machining area 48 through the door that is in an opened state. Further, the operator can easily confirm the condition within the machining area 48 via the window.

The coolant supply device 32 is a device that supplies the coolant to the machining area 48. The coolant supply device 32 is equipped with a coolant tank 50, a nozzle 52, a supply pipe 54, and a pump 56.

The coolant tank 50 is a tank for storing coolant. The coolant tank 50 is installed externally of the machining area 48.

The nozzle 52 is a discharge unit that discharges the coolant. The nozzle 52 is disposed within the machining area 48. Moreover, the coolant supply device 32 may be equipped with a plurality of the nozzles 52.

The supply pipe 54 is a pipe that connects the coolant tank 50 and the nozzle 52. Moreover, the coolant supply device 32 may be equipped with a plurality of the supply pipes 54. The number of the supply pipes 54 is determined, for example, in accordance with the number of the nozzles 52. The supply pipe 54 passes through the cover 30, and connects the coolant tank 50 and the nozzle 52.

The pump 56 is connected to the supply pipe 54. The pump 56 draws in the coolant within the coolant tank 50, and delivers the coolant to the nozzle 52. Consequently, the coolant is discharged from the nozzle 52 into the machining area 48. The pump 56 is controlled by the control device 14.

The coolant that is discharged into the machining area 48 cools the tool 16 and the workpiece. The coolant discharged to the machining area 48 is vaporized, and the vaporized mist is generated in the machining area 48.

The mist collector 34 is a device that serves to collect the mist within the machining area 48. The mist collector 34 is installed externally of the machining area 48. Further, the mist collector 34 is connected to the cover 30 via a duct 58. The mist collector 34 collects the mist by drawing in air within the machining area 48. In accordance with this feature, the mist is prevented from leaking out to the exterior of the machining area 48 via small gaps that occur in the machining device 12.

In the case that a workpiece is cut by the tool 16, fine or minute cutting chips are generated in the form of powdery dust within the machining area 48. In the case that the mist collector 34 draws in air within the machining area 48, not only the mist but also the powdery dust is collected by the mist collector 34. In accordance with this feature, the powdery dust is also prevented from leaking out to the exterior of the machining area 48 via small gaps that occur in the machining device 12.

The mist collector 34 may be connected to the coolant tank 50. Consequently, the mist that is collected by the mist collector 34 can be returned, as the coolant, to the coolant tank 50.

In the case that the mist collector 34 and the coolant tank 50 are connected to each other, it is preferable for the mist collector 34 and the coolant tank 50 to be connected to each other via a non-illustrated filtering device (filter). The filtering device removes impurities from the coolant that is delivered from the mist collector 34 to the coolant tank 50. By connecting the mist collector 34 and the coolant tank 50 via the filtering device, a clean coolant can be returned from the mist collector 34 to the coolant tank 50. Impurities in the coolant, for example, are the cutting chips that have been collected together with the mist.

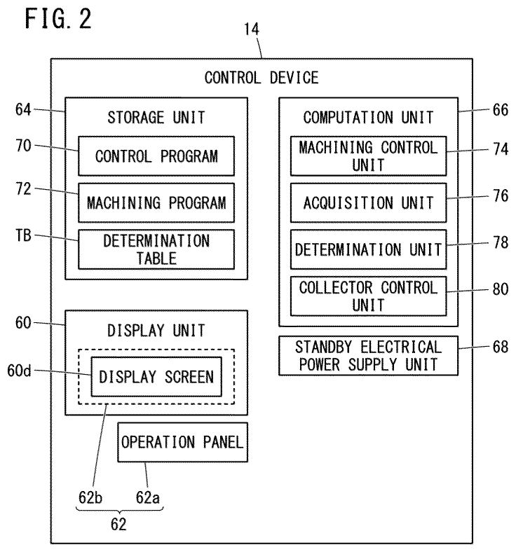

FIG. 2 is a block diagram of the control device 14.

The control device 14 is a computer that controls the machining device 12. The control device 14, for example, is a numerical control device. The control device 14 is equipped with a display unit 60, an operation unit 62, a storage unit 64, a computation unit 66, and a standby electrical power supply unit 68.

The display unit 60 is a display device equipped with a display screen 60d. The display unit 60, for example, is a liquid crystal display device or an OEL (Organic Electro-Luminescence) display device.

The operation unit 62 is an input device that receives instructions from the operator to the control device 14. The operation unit 62 includes, for example, an operation panel 62a, and a touch panel 62b or the like. The touch panel 62b is provided on the display screen 60d. The operation unit 62 (the operation panel 62a) may be equipped with a keyboard, a mouse, or the like.

The storage unit 64 is constituted by a non-illustrated volatile memory, and a non-illustrated nonvolatile memory. As an example of the volatile memory, there may be cited a random access memory (RAM) or the like. As an example of the nonvolatile memory, there may be cited a ROM (Read Only Memory) and a flash memory or the like. Data and the like may be stored, for example, in the volatile memory. Programs, tables, maps, etc. may be stored, for example, in the nonvolatile memory. At least a portion of the storage unit 64 may be included in a processor, an integrated circuit, or the like. In the present embodiment, the storage unit 64 stores a control program 70 and a machining program 72.

The control program 70 is a program for the purpose of causing the control device 14 to execute the control method according to the present embodiment. The control method will be described later.

The machining program 72 is a program including control commands for the machining device 12. The machining program 72 includes, for example, a plurality of control commands for the purpose of controlling each of the aforementioned motors. Further, the machining program 72 also includes, for example, a plurality of control commands for the purpose of controlling the coolant supply device 32. The machining program 72 is created or edited in advance by the operator.

The computation unit 66 is constituted by a processor including, for example, a CPU (Central Processing Unit), and a GPU (Graphics Processing Unit) or the like. The computation unit 66 includes a processing circuitry.

The computation unit 66 includes a machining control unit 74, an acquisition unit 76, a determination unit 78, and a collector control unit 80. The machining control unit 74, the acquisition unit 76, the determination unit 78, and the collector control unit 80 are realized by the processor of the computation unit 66 executing the control program 70. At least a portion of the machining control unit 74, the acquisition unit 76, the determination unit 78, and the collector control unit 80 may be realized by an integrated circuit such as an ASIC (Application Specific Integrated Circuit) or an FPGA (Field-Programmable Gate Array). At least a portion of the machining control unit 74, the acquisition unit 76, the determination unit 78, and the collector control unit 80 may be configured by an electronic circuit including a discrete device.

The machining control unit 74, by controlling the machining device 12 based on the machining program 72, carries out machining on the workpiece. The machining control unit 74 controls the mounting of the tool 16, the rotation of the spindle 18, the movement of the spindle head 20, the movement of the table 26, and the like. However, the mist collector 34 of the machining device 12 is controlled by the collector control unit 80.

The acquisition unit 76 acquires a type of the tool 16 used for machining a workpiece. The acquisition unit 76 starts to acquire the type of the tool 16 in the case that the mounting of the tool 16 is detected. The mounting of the tool 16 is performed before the machining of the workpiece is started. The mounting of the tool 16 includes a case that the tool 16 is changed with a new tool 16. The detection of the mounting of the tool 16 is performed by a switch, a sensor, or the like provided in the spindle head 20. In this case, the acquisition unit 76 recognizes the case that the mounting of the tool 16 is detected based on the detection signal output from the switch, the sensor, or the like, and starts to acquire the type of the tool 16.

The acquisition unit 76 may acquire the type of the tool 16 based on the tool identification information. In this case, a tool table stored in the storage unit 64 is used. In the tool table, the tool identification information and the type information indicating the type of the tool 16 are associated with each other. The tool identification information is information for identifying the tool 16 and includes at least one of a tool number, a tool weight, a tool diameter, a tool length, and a tool run-out degree. The tool run-out degree is a run-out degree (run-out width from the rotary axis) of the tool 16 rotating at a predetermined rotation speed.

For example, the acquisition unit 76 can acquire the type of the tool 16 corresponding to the tool number included in the machining program 72 by using the tool table. For example, the acquisition unit 76 can acquire the type of the tool 16 corresponding to at least one of the tool weight, the tool diameter, the tool length, and the tool run-out degree detected by a detection mechanism, using the tool table. The detection mechanism includes a camera, a measurement instrument, a sensor, and the like attached to the machining device 12. Examples of the sensor include a weight sensor and a vibration sensor.

The acquisition unit 76 may acquire the type of the tool 16 input from the operation unit 62 in accordance with an operation by an operator. In this case, the acquisition unit 76 may control the display unit 60 or the like to notify the operator that the type of the tool 16 should be input.

The determination unit 78 determines whether to permit or prohibit the operation of the mist collector 34 based on the type of the tool 16 acquired by the acquisition unit 76. In this case, a determination table TB stored in the storage unit 64 is used. In the determination table TB, type information indicating the type of the tool 16 and state information indicating whether the operation of the mist collector 34 is permitted or prohibited are associated with each other. For example, when the type information indicates a milling cutter or a drill, the determination unit 78 determines that the operation of the mist collector 34 is permitted. When the type information indicates a spring-necked turning tool or an end mill, the determination unit 78 determines that the operation of the mist collector 34 is prohibited.

When the type information indicates the type of the tool 16 used for precision machining, the determination unit 78 may determine to prohibit the operation of the mist collector 34. When the type information indicates the type of the tool 16 having a natural frequency that matches or approximates the vibration of the mist collector 34, the determination unit 78 may determine to prohibit the operation of the mist collector 34.

The collector control unit 80 controls the mist collector 34 based on the determination result of the determination unit 78. In the case that the determination unit 78 has determined to permit the operation of the mist collector 34, the collector control unit 80 turns ON the operation of the mist collector 34. In this case, the mist collector 34 is automatically started from the timing when the operation of the mist collector 34 is turned ON, and starts the collection of the mist.

On the other hand, in the case that the determination unit 78 determines that the operation of the mist collector 34 is prohibited, the collector control unit 80 turns OFF the operation of the mist collector 34. In this case, the mist collector 34 is not started.

The standby electrical power supply unit 68 is an electrical power supply that is separate from the main power supply of the control device 14. The standby electrical power supply unit 68 includes, for example, a battery. The standby electrical power supply unit 68 is integrated in the control device 14. However, the standby electrical power supply unit 68 may be provided in the machine tool 10 as an external power supply for the control device 14. Moreover, it should be noted that the main power supply for the control device 14 is not shown in the drawings.

In the case that the main power supply of the control device 14 is turned OFF while the mist collector 34 is in operation, the standby electrical power supply unit 68 supplies electrical power to each of the components of the control device 14. In accordance with this feature, even after the main power supply has been turned OFF, the collector control unit 80 can continue to control the mist collector 34.

If electrical power is supplied to the mist collector 34 from a power supply other than the main power supply of the control device 14, the mist collector 34 can continue to operate even when the main power supply of the control device 14 is turned OFF. In such a case, the main power supply of the control device 14 may be turned OFF before the collector control unit 80 stops the mist collector 34. In such a case, by supplying electrical power from the standby electrical power supply unit 68, the collector control unit 80 can cause the mist collector 34 to be automatically stopped even after the main power supply of the control device 14 is turned OFF. In accordance with this feature, the wasteful power consumption of the mist collector 34 is suppressed.

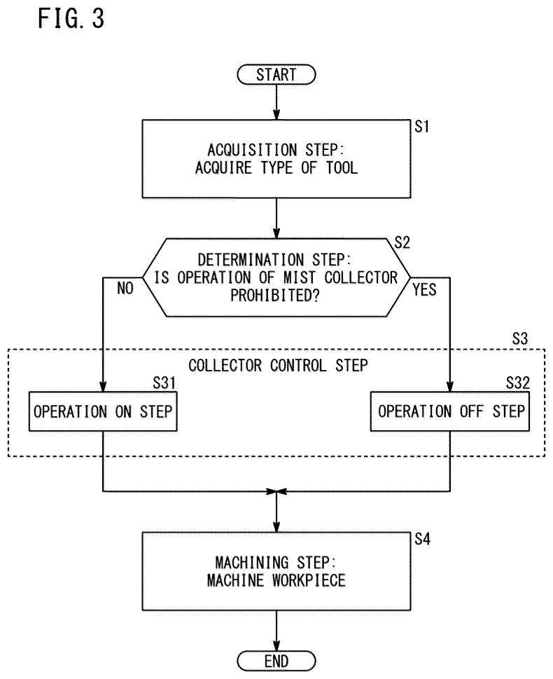

FIG. 3 is a flowchart illustrating the control method according to the embodiment.

The control device 14 can execute a control method, for example, as illustrated in FIG. 3. The control method of FIG. 3 includes an acquisition step S1, a determination step S2, a collector control step S3, and a machining step S4. The collector control step S3 includes an operation ON step S31 and an operation OFF step S32. The acquisition step S1, the determination step S2, and the collector control step S3 are executed before the machining on the workpiece is started.

The acquisition step S1 is a step of acquiring the type of the tool 16. In the acquisition step S1 according to the present embodiment, the type of the tool 16 is acquired by the acquisition unit 76. When the mounting of the tool 16 to the spindle 18 is detected, the acquisition unit 76 analyzes the machining program 72 by which the mounting of the tool 16 has been executed and acquires the type of the tool 16.

The determination step S2 is a step of determining whether to permit or prohibit the operation of the mist collector 34 based on the type of the tool 16 acquired in the acquisition step S1. In the determination step S2 according to the present embodiment, whether the operation of the mist collector 34 is permitted or prohibited by the determination unit 78 is determined by the determination unit 78 based on the determination table TB.

If the state information of the determination table TB corresponding to the type of the tool 16 acquired in the acquisition step S1 indicates permission of the operation of the mist collector 34 (S2: NO), the determination unit 78 determines that the operation of the mist collector 34 is permitted. Conversely, if the state information of the determination table TB corresponding to the type of the tool 16 acquired in the acquisition step S1 indicates prohibition of the operation of the mist collector 34 (S2: YES), the determination unit 78 determines that the operation of the mist collector 34 is prohibited. Depending on the determination content in the determination step S2, the operation ON step S31 or the operation OFF step S32 is started.

The operation ON step S31 is a step in which the mist collector 34 is turned ON to operate. In the operation ON step S31 according to the present embodiment, the collector control unit 80 turns ON the operation of the mist collector 34. In this case, the machining of the workpiece is started after the collection of the mist by the mist collector 34 is started.

The operation OFF step S32 is a step in which the mist collector 34 is turned OFF so as not to operate. In the operation OFF step S32 according to the present embodiment, the collector control unit 80 turns OFF the operation of the mist collector 34. In this case, the machining on the workpiece is started without collecting the mist by the mist collector 34.

The machining step S4 is a step of machining a workpiece. In the machining step S4 according to the present embodiment, the workpiece is machined under the control of the machining control unit 74 to the machining device 12. In this case, the machining control unit 74 machines the workpiece based on the machining program 72 by which the mounting of the tool 16 to the spindle 18 is executed.

If the operation of the mist collector 34 is turned OFF in the collector control step S3, the control method of FIG. 3 is brought to an end when the machining on the workpiece is completed. If the operation of the mist collector 34 is turned ON in the collector control step S3, the collector control unit 80 stops the mist collector 34 at the timing when the machining on the workpiece is completed. In this case, when the stopping of the mist collector 34 is completed, the control method of FIG. 3 is completed.

As described above, in the present embodiment, the type of the tool 16 used for machining the workpiece is acquired, and it is determined whether the operation of the mist collector 34 is permitted or prohibited based on the type of the tool 16. If the determination is made to permit the operation of the mist collector 34, the operation by the mist collector 34 is turned ON, and if the determination is made to prohibit the operation of the mist collector 34 is made, the operation by the mist collector 34 is turned OFF.

In accordance with such features, for example, in the case that a workpiece is machined by a tool 16 used for precision machining, the collection of mist by the mist collector 34 can be stopped. Therefore, it is possible to prevent the vibration generated by the mist collector 34 from affecting the machining on the workpiece. As a result, it is possible to suppress a reduction in the machine accuracy. In addition, since the mist collector 34 is stopped, the electric power consumption of the mist collector 34 is suppressed. Further, the operation of the mist collector 34 can be turned ON and OFF regardless of the coolant discharge state.

### EXEMPLARY MODIFICATIONS

Hereinafter, a description will be given concerning exemplary modifications of the above-described embodiment. However, any descriptions that are duplicative or overlap with those of the above-described embodiment will be appropriately omitted in the following description. Unless otherwise specified, the same reference numerals as in the above-described embodiment are used in referring to the elements that have already been described in the embodiment.

### Exemplary Modification 1

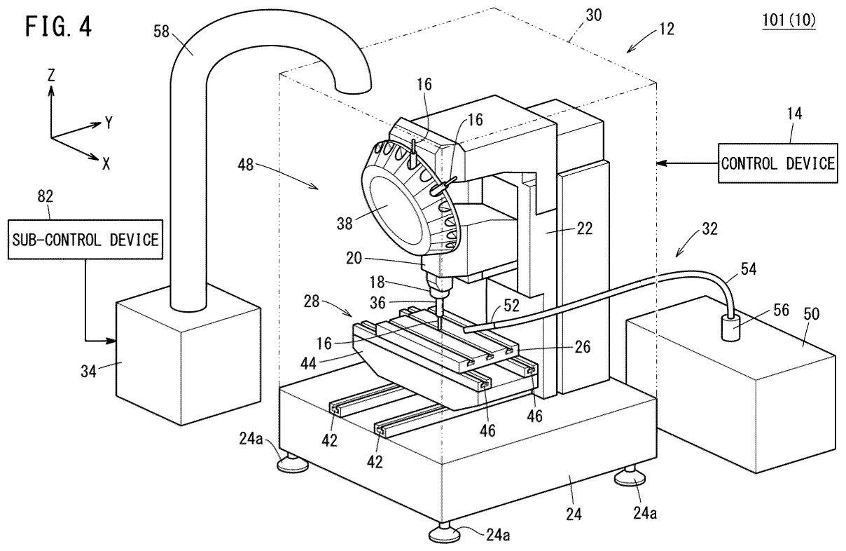

FIG. 4 is a schematic diagram of a machine tool 101 (10) according to an exemplary modification 1. The machine tool 101 is further equipped with a sub-control device 82. In the machine tool 101, the standby electrical power supply unit 68 of the control device 14 may be omitted.

The sub-control device 82 is a computer that is separate from the control device 14. The sub-control device 82, for example, is equipped with a processor and a memory. The sub-control device 82 may also be equipped with an integrated circuit, a discrete device, or the like.

In the case that the control device 14 is stopped, the sub-control device 82 controls the mist collector 34 instead of the collector control unit 80. Therefore, even if the control device 14 is stopped, the mist collector 34 is controlled by the sub-control device 82 in the same manner as in the embodiment.

For example, in the case that the machining is completed, the operator issues an instruction to the control device 14 to immediately stop the machining. Consequently, the control device 14 immediately stops the machining after the completion of the machining. However, as noted previously, it is preferable for the mist collector 34 to collect the mist until the predetermined time period has elapsed from the completion of the machining. In such a case, the sub-control device 82 is capable of controlling the mist collector 34 instead of the control device 14.

For example, if the main power supply of the control device 14 is turned OFF before the collector control unit 80 causes the mist collector 34 to be stopped, the sub-control device 82 can control the mist collector 34, instead of the control device 14.

Moreover, it is preferable for the sub-control device 82 and the control device 14 to communicate with each other as appropriate, and to share the data necessary for controlling the mist collector 34. For example, the sub-control device 82 and the control device 14 share the type of the tool 16 acquired by the acquisition unit 76, the determination content by the determination unit 78, or the progress of the machining. In accordance with these features, the sub-control device 82 is capable of smoothly taking over the control that was being performed by the collector control unit 80. According to the present exemplary modification, even after the control device 14 is stopped, the control of the mist collector 34 can be continued by the sub-control device 82.

### Exemplary Modification 2

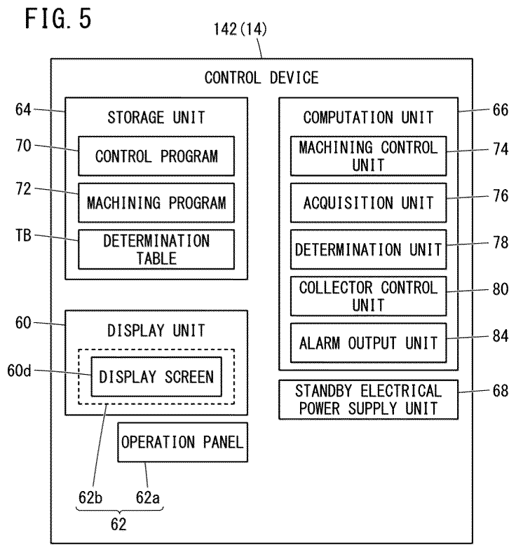

FIG. 5 is a block diagram of a control device 142 (14) according to an exemplary modification 2. The control device 142 is further equipped with an alarm output unit 84.

The alarm output unit 84 outputs an alarm in the case that an abnormality has occurred in the machine tool 10. For example, the machine tool 10 is appropriately provided with non-illustrated sensors for the purpose of detecting malfunctions or troubles in each of the respective components such as the spindle 18, the spindle head 20, the table drive unit 28, etc. The alarm output unit 84 determines whether or not a malfunction has occurred in the machine tool 10 based on the signals output by the sensors. In the case that a malfunction is detected in any of the respective components of the machine tool 10, the alarm output unit 84 issues a notification to the operator, for example via the display unit 60, to the effect that a malfunction has occurred.

In the case that the alarm output unit 84 has output an alarm prior to the start of the machining, the machining control unit 74 does not start the machining until the cause of the alarm is eliminated. Further, in the case that the alarm output unit 84 has output an alarm after the start of the machining, the machining control unit 74 suspends the machining based on the machining program 72 until the cause of the alarm is eliminated.

On the other hand, in the case that an alarm is output and the operation of the mist collector 34 is ON, the collector control unit 80 stops the operation of the mist collector 34 until the cause of the alarm is eliminated. In accordance with such features, it is possible to prevent the mist collector 34 from continuing to operate in case of emergency of the machine tool 10. However, in the case that an operator instructs to start operation at the time of abnormal stop of the machining device 12, the collector control unit 80 may restart the operation of the mist collector 34.

### Combination of Plural Exemplary Modifications

The above-described plurality of exemplary modifications may be combined as appropriate within a range in which there are no contradictions therebetween.

### Modified Embodiments

It should be noted that the present invention is not limited to the embodiment described above, and various alternative or additional configurations may be adopted therein without departing from the essence and gist of the present invention.

For example, according to the above embodiment, the mist collector 34 stops when the machining control unit 74 completes the machining. However, the collector control unit 80 may control the mist collector 34 to cause the mist collector 34 to collect the mist in the machining area 48 until a predetermined time period has elapsed from the completion of the machining. By intentionally operating the mist collector 34 after the completion of the machining, it is possible to prevent a loss in the collection of the mist. The predetermined time period is specified in advance to the collector control unit 80 by, for example, an operator through the operation unit 62. However, the predetermined time period may be specified by the manufacturer of the machine tool 10.

In addition, for example, according to the above-described embodiment, the collector control unit 80 causes the mist collector 34 to start to collect the mist before the machining on the workpiece is started. However, the collector control unit 80 may cause the mist collector 34 to start to collect the mist after a predetermined stand-by time has elapsed from the start of the machining of the workpiece. By intentionally operating the mist collector 34 after the start of the machining, it is possible to suppress the electric power consumption of the mist collector 34. The stand-by time is specified in advance to the collector control unit 80 by, for example, an operator through the operation unit 62. However, the stand-by time may be specified by the manufacturer of the machine tool 10.

For example, the collector control unit 80 may receive instructions from the operator to permit the operation of the mist collector 34, during a period from the time when the determination is made to prohibit the operation of the mist collector 34 to the time when the machining on the workpiece is completed. When the instructions to permit the operation of the mist collector 34 are issued, the collector control unit 80 turns ON the operation of the mist collector 34 even if the determination to prohibit the operation has been made. Similarly, the collector control unit 80 may receive instructions from the operator to prohibit the operation of the mist collector 34, during a period from the time when the determination is made to permit the operation of the mist collector 34 to the time when the machining on the workpiece is completed. When the instructions to prohibit the operation of the mist collector 34 are issued, the collector control unit 80 turns OFF the operation of the mist collector 34 even if the determination to permit the operation has been made. In this way, when the collector control unit 80 receives the instructions from the operator to permit or prohibit the operation of the mist collector 34, the collector control unit 80 gives priority to the instructions and turns ON or OFF the operation of the mist collector 34, regardless of the determination by the determination unit 78. In accordance with this feature, it is possible to turn ON or OFF the operation of the mist collector 34 with priority given to the operator's intention.

For example, the determination unit 78 may determine whether to permit or prohibit the operation of the mist collector 34 based on the type of the tool 16 and the material of the workpiece. The material of the workpiece may be added to the determination table TB or may be input by an operator. By adding the material of the workpiece to the determination conditions of the determination unit 78, it is possible to define in detail the case in which the operation of the mist collector 34 is permitted and the case in which the operation of the mist collector 34 is prohibited. The vibration generated while the workpiece is being machined (machining vibration) may resonate with the vibration generated by the mist collector 34 (collector vibration). The machining vibration depends not only on the tool 16 but also on the material of the workpiece. Therefore, by adding the material of the workpiece to the determination conditions of the determination unit 78, it is possible to appropriately determine to prohibit the operation of the mist collector 34 in the case where there is a possibility that the collector vibration and the machining vibration resonate.

For example, the machining control unit 74 may control the pump 56 of the coolant in accordance with the operating state of the mist collector 34. That is, if the determination unit 78 determines to permit the operation of the mist collector 34, the machining control unit 74 drives the pump 56 of the coolant. On the other hand, if the determination unit 78 determines to prohibit the operation of the mist collector 34, the machining control unit 74 does not drive the pump 56 of the coolant. In this way, it is possible to prevent the vibration generated by the coolant supply device 32 from affecting the machining on the workpiece.

Also, for example, the state information may be optionally defined in the machining program 72. In this case, the determination unit 78 can determine whether to permit or prohibit the operation of the mist collector 34 based on the machining program 72. Therefore, the determination table TB need not be stored in the storage unit 64. Therefore, it is possible to reduce the storage capacity of the storage unit 64.

Further, for example, the coolant discharge method is not limited to being that of the embodiment. For example, the coolant may be discharged using a center-through method. In that case, the coolant supply device 32 supplies the coolant to the spindle 18. Further, the coolant may flow along the inner wall of the cover 30 (the machining area 48).

For example, the machining device 12 may further be equipped with a non-illustrated recovery member in order to recover the coolant that falls downwardly of the table 26. Such a recovery member, for example, is an oil pan provided on the pedestal 24. A portion of the coolant supplied to the machining area 48 falls downwardly of the table 26 without turning into a mist. According to the present exemplary modification, it is possible to collect the coolant that has fallen downwardly of the table 26. The recovered coolant may be returned to the coolant tank 50. In accordance with this feature, the coolant supply device 32 is capable of reusing the coolant that has been collected. In this instance, it is preferable for a filtering device (a filter) to be disposed between the recovery member and the coolant tank 50. In accordance with this feature, a clean coolant can be returned to the coolant tank 50.

### Invention Obtained from the Embodiment

Invention that can be grasped from the above-described embodiment and the exemplary modifications thereof will be described below.

(1) The first aspect of invention is the control device (14) for the machine tool (10) including the mist collector (34) configured to collect mist in the machining area (48), the machine tool being configured to machine the workpiece within the machining area, the control device including the acquisition unit (76) configured to acquire the type of the tool (16) used for performing machining on the workpiece, the determination unit (78) configured to determine whether to permit or prohibit the operation of the mist collector based on the type of the tool, and the collector control unit (80) configured to turn ON the operation of the mist collector in the case that the determination has been made to permit the operation of the mist collector, and turn OFF the operation of the mist collector in the case that the determination has been made to prohibit the operation of the mist collector.

In accordance with such features, for example, in the case that the workpiece is machined by the tool used for precision machining, the collection of mist by the mist collector can be stopped. Therefore, it is possible to prevent the vibration generated by the mist collector from affecting the machining on the workpiece. As a result, it is possible to suppress degradation of the machine accuracy.

(2) The first aspect of the present invention is the control device, wherein the collector control unit may use the determination table (TB) in which type information indicating the type of the tool and state information indicating whether to permit or prohibit the operation of the mist collector are associated with each other. In accordance with this feature, it is possible to manage the tool for turning ON or OFF the operation of the mist collector.

(3) The first aspect of the present invention is the control apparatus, wherein the collector control unit may turn OFF the operation of the mist collector in the case that the type of the tool used for precision machining has been acquired. In accordance with this feature, it is possible to suppress degradation of the machine accuracy in the precision machining.

(4) The first aspect of the present invention is the control device, wherein the acquisition unit may start to acquire the type of the tool that is mounted in the case that mounting of the tool is detected. In accordance with this feature, even if the tool is changed, it is possible to turn ON or OFF the operation of the mist collector based on the type of tool after being changed.

(5) The first aspect of the present invention is the control device, wherein the collector control unit may determine whether to permit or prohibit the operation of the mist collector before the machining of the workpiece is started. In accordance with this feature, in the case that the machining is to be performed using the type of the tool with which the operation of the mist collector is prohibited, it is possible to prevent beforehand the operation of the mist collector from being turned ON before the machining is performed.

(6) The first aspect of the present invention is the control device, wherein in the case that the determination has been made to permit the operation of the mist collector, the collector control unit may stop driving the mist collector after the predetermined time period has elapsed from completion of the machining on the workpiece. In accordance with this feature, the amount of the mist that remains in the machining area after the completion of the machining can be reduced, while the electrical power consumption of the mist collector can be prevented from becoming excessively large.

(7) The first aspect of the present invention is the control device, which may further include the alarm output unit (84) configured to output the alarm in the case that the abnormality has occurred in the machine tool, wherein, in the case that the alarm is output while the operation of the mist collector is ON, the collector control unit may stop the operation of the mist collector. In accordance with such features, it is possible to prevent the mist collector from continuing to operate in case of emergency of the machine tool.

(8) A second invention is a machine tool (10) including the control device according to the first aspect of invention. Since the control device according to the first aspect of the present invention is included, it is possible to suppress degradation of the machine accuracy.

(9) The second aspect of the present invention is the machine tool, which may further include the sub-control device (82) configured to control the mist collector instead of the collector control unit in the case that the control device is stopped. In accordance with this feature, even if the control device is stopped, the mist collector can be controlled.

(10) A third aspect of invention is the control method for controlling by a computer (14) the machine tool including the mist collector configured to collect mist in the machining area, the machine tool being configured to machine the workpiece within the machining area, the control method including the acquisition step (S1) of acquiring the type of the tool used for performing machining on the workpiece, the determination step (S2) of determining whether to permit or prohibit the operation of the mist collector based on the type of the tool, and the collector control step (S3) of turning ON the operation of the mist collector in the case that the determination has been made to permit the operation of the mist collector, and turning OFF the operation of the mist collector in the case that the determination has been made to prohibit the operation of the mist collector.

In accordance with such features, for example, in the case that the workpiece is machined by the tool used for precision machining, the collection of mist by the mist collector can be stopped. Therefore, it is possible to prevent the vibration generated by the mist collector from affecting the machining on the workpiece. As a result, it is possible to suppress degradation of the machine accuracy.

### REFERENCE SIGNS LIST

10, 101: machine tool
12: machining device
14, 142: control device
32: coolant supply device
34: mist collector
48: machining area
72: machining program
74: machining control unit
76: acquisition unit
78: determination unit
80: collector control unit
82: sub-control device
84: alarm output unit
TB: determination table

1. A control device for a machine tool comprising a mist collector configured to collect mist in a machining area, the machine tool being configured to machine a workpiece within the machining area, the control device comprising:
an acquisition unit configured to acquire a type of a tool used for performing machining on the workpiece;
a determination unit configured to determine whether to permit or prohibit an operation of the mist collector based on the type of the tool; and
a collector control unit configured to turn ON the operation of the mist collector in a case that a determination has been made to permit the operation of the mist collector, and turn OFF the operation of the mist collector in a case that a determination has been made to prohibit the operation of the mist collector.

2. The control device according to claim 1, wherein the collector control unit uses a determination table in which type information indicating the type of the tool and state information indicating whether to permit or prohibit the operation of the mist collector are associated with each other.

3. The control device according to claim 1, wherein the collector control unit turns OFF the operation of the mist collector in a case that the type of the tool used for precision machining has been acquired.

4. The control device according to claim 1, wherein the acquisition unit starts to acquire the type of the tool that is mounted in a case that mounting of the tool is detected.

5. The control device according to claim 1, wherein the collector control unit determines whether to permit or prohibit the operation of the mist collector before the machining of the workpiece is started.

6. The control device according to claim 1, wherein in the case that the determination has been made to permit the operation of the mist collector, the collector control unit stops driving the mist collector after a predetermined time period has elapsed from completion of the machining on the workpiece.

7. The control device according to claim 1, further comprising an alarm output unit configured to output an alarm in a case that an abnormality has occurred in the machine tool,
wherein, in a case that the alarm is output while the operation of the mist collector is ON, the collector control unit stops the operation of the mist collector.

8. A machine tool comprising the control device according to claim 1.

9. The machine tool according to claim 8, further comprising a sub-control device configured to control the mist collector instead of the collector control unit in a case that the control device is stopped.

10. A control method for controlling by a computer a machine tool comprising a mist collector configured to collect mist in a machining area, the machine tool being configured to machine a workpiece within the machining area, the control method comprising:
an acquisition step of acquiring a type of a tool used for performing machining on the workpiece;
a determination step of determining whether to permit or prohibit an operation of the mist collector based on the type of the tool; and
a collector control step of turning ON the operation of the mist collector in a case that a determination has been made to permit the operation of the mist collector, and turning OFF the operation of the mist collector in a case that a determination has been made to prohibit the operation of the mist collector.
